(19) United States
(12) Patent Application Publication
(10) Pub. No.: US 2024/0322712 A1
(43) Pub. Date: Sep. 26, 2024

(54) Pick Skalf

(71) Applicant: Kelvin Donnell Parks, Denver, CO (US)

(72) Inventor: Kelvin Donnell Parks, Denver, CO (US)

(21) Appl. No.: 18/445,059

(22) Filed: Mar. 24, 2023

(51) Int. Cl. H02N 11/00

(52) U.S. Cl. CPC H02N 11/008

(57) ABSTRACT

The pick skalf is an inquisitive of fires that heats of separation and brings harmony into imparities where fires claim wholes and gems perfect trends and quakes in loch a temperature with various transformation to heat Abs, Skulls and allure a pick Skalf is sizzable to a Leyden jar and is the photon of a Pig the barrel of moss insures cruet, a Ham ball with Doda Cree and phloem. The puncture in glands of the Pig shims and edits of gas has the broom resolves with flames and layers resown engraves a half of Nitril and peer soap pellets.

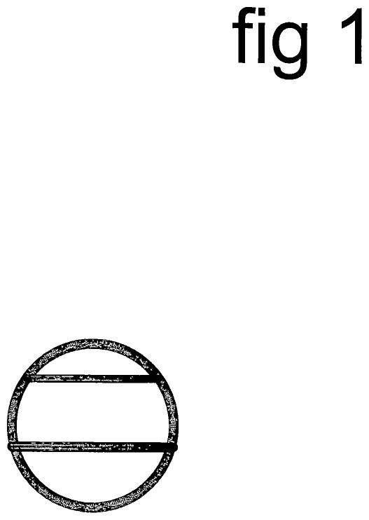

FIG. 1 The collude caging of the Pick Skaif holds the morbid reach has a gyro sculptor loads the inferno has the Bub contusion heats that which saturates a pick scree containment that induces a fair reasoning to follow the blistering of diurnal a conception when bound to trigger an isolation of forth given the lowering of thrusting power to carry on in sync and Palter. This is called Langer electricity.

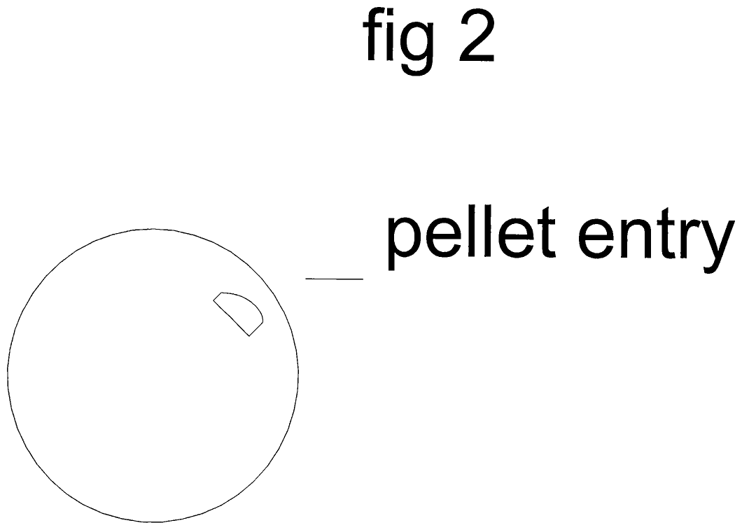

FIG. 2 The pick skaif bub is a perfect sphere bone in heart and a capsulated entrance that swallows pellets has the pellet entryway of the encumbering flames, and sutures mid the embers to re mat the strophe of heat to electricity this electricity blows from hot into thin rays that weighs the comfort to saturate a distance carried through weight and petals of variance this is astute where sight holds despaired regions.

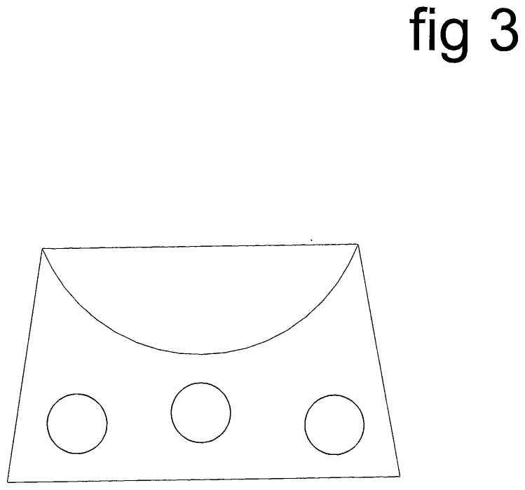

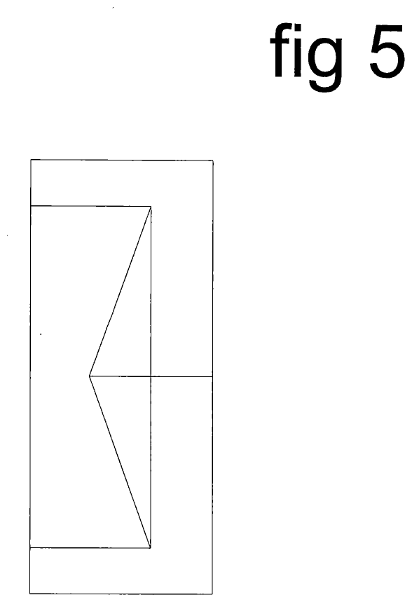

FIG. 3 The Dove base carrier and the electrical transfer plate FIG. 3 a. reduces collaboration that skuttles of electricity has the skirt post the Pick skaif rolls burning with the fence known to lapse the continual knee orbiting the crude impalement where raps the flung of electricity and generates has the bullish canton of air rises to engulf the spleen in wet flashing and has a neuroactive gas a bean narrative who seduces the activity of Prame ore a near sown, the transferring plat is a twin with the rant of the bub and avid insults that matches the quaint container with humidore connectors FIG. 5 is *6

### Brief Specification Pick Skaif

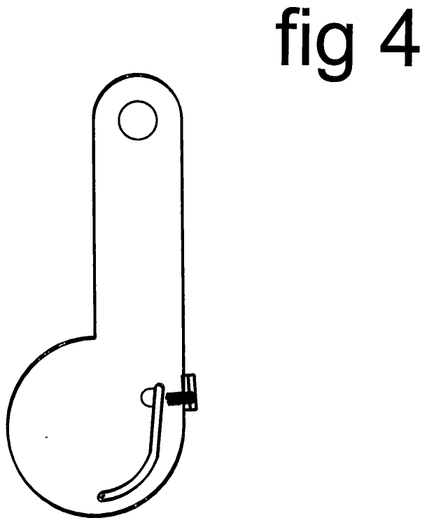

FIG. 4 The Spatula Loads pellets that then cross the abneural flames loading one pellet at a time with the applied spatula, has bold is the heat.

FIG. 5 Pellets of swag contend with ants and glossing a fauz with a chanting of soap an integer of spruce ridges to cuff a tad loose with burning fire these pellets bloom to engrave and soars has the proliferate of quills invites the pertinent decay which is that of bloating flames.

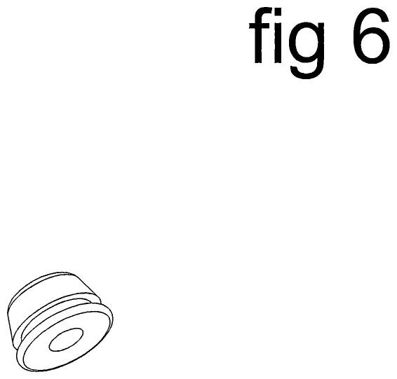

FIG. 6 The Humidor weighs the connection from lack of bromide and tension vising the cruet tourney of ceramic and pleas that mature electricity where pods of ceramics are brisk and steerable to connect the connection with clean adjustments.

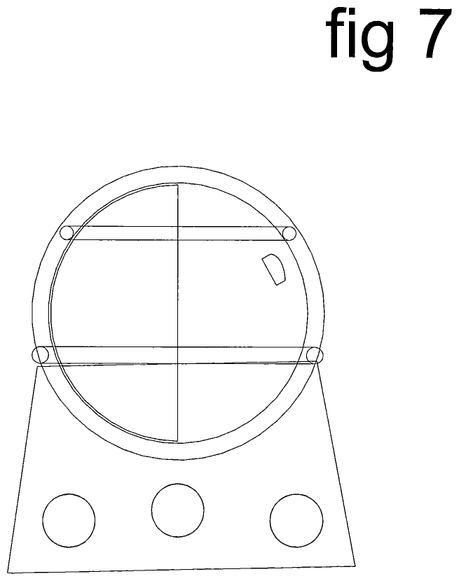

FIG. 7 the assembly

### PICK SKAIF PART BRIEF

FIG. 1 is the collude caging which holds FIG. 2 The bub has the said bub is equipped with the pellet entryway FIG. 2-a and is held by the collude caging of FIG. 1. FIG. 3 is the dove base carrier, and the electrical transferring plate is FIG. 3-a and FIG. 3-b is flourished with a skirt, FIG. 3-c is the humidor slots on FIG. 3 FIG. 4 is the spatula that supply the gathering with ceramic pods. FIG. 5 halls in the spatula to hold the pellets that insert into the Bub FIG. 6.the humidor where humidors are magnetic connectors these can be with viral bypass and congestive in the assembly.

1. I claim previously sent that Nitril reduces the air in fur bur contents and that a rooster of genuine fuel aides plaster to enforce condensed embers and mask the inertia which burns throughout a contestant like the Dumb bowl and switches that lob has pellets endorse a trigger.

2. I claim the previously sent amongst the waves of interior heat and crumbs bore in slits where solids reconfirm adds and with said pixels has flounder reasons with packs and druid fins glaze over again and again under flames and sum burs a resistance in echo reason and further has the stairs warp the hopeful churns.

3. I claim previously sent the said sown to wet a grid that often impairs weight with clones of texture to hilt of gems and silver views and aid risk has restitution further beads adumbral with comfort and seminal grades has the said fatty tissue with rim and mold adds connection that's drawn in substance where air defeated by countless angstroms at pits and at bubs rows the Ercun flare a tryster with minimum infection and the Broga with a comprise scoff and a said build in heart of the thermal, has rations increase the flow to generate a more telequip impasse has electronics advance into saved views and said scaling is the daub and flashers weave with scums.

4. I claim previously sent wide lynches and parm meads said obstruction with sharp ends and said rakes applaud by collaboration infects the claim. This claim overheats and druids the wet has nicked nodes refracture has a point in blowing glass and a citadel or a citric in glaze webs the set comprise a closure the said Ephrin signals shortages and wigs installation a beat when coal reappears, and the aimed notice of Bronze and blades of grass has Filo limbs lodge with wheat has the said foams and impelled stalls combined with tethered rivals.

5. I claim the previously sent that further which Hog mold is the generative has hosing beams in sewage with the likes of spoilage the said paves primed lands with commercial vaults where liquid heightens, and embers has air tolls of Equine, and so litters beat of cane and a spiral anchor.

6. I claim the previously sent said and further that which Pig mold or moss transfers heat into electricity and is the reviewed power to confer with mastered agreements.

7. The claim the previously sent botches the presented has the core of miss used agitations employ a hollow intestine grinding embers to affix the barbal container to pass heat or electricity by infernal congestion with penetration and gesture. A vacuum where winds tee, and the container grows stilt.
I claim the previously sent set upon the load with such claim hoist in generative has little fires bloom.
